(19) United States
(12) Patent Application Publication
(10) Pub. No.: US 2023/0325396 A1
(43) Pub. Date: Oct. 12, 2023

(54) REAL-TIME CONTENT ANALYSIS AND RANKING

(71) Applicant: Robert Christopher Technologies Ltd., Manasquan, NJ (US)

(72) Inventors: Robert Hendrickson, Manasquan, NJ (US); Patrick Migliaccio, West Long Branch, NJ (US); Michael McNulty, Manasquan, NJ (US); Brian Burrows, Fuquay-Varina, NC (US)

(21) Appl. No.: 18/209,414

(22) Filed: Jun. 13, 2023

Related U.S. Application Data
(62) Division of application No. 17/051,918, filed on Oct. 30, 2020.
(60) Provisional application No. 62/673,495, filed on May 18, 2018.

(51) Int. Cl. G06F 16/2458; G06F 16/242; G06N 20/00; G06F 16/28; H04L 9/06

(52) U.S. Cl. CPC G06F 16/2465; G06F 16/2425; G06N 20/00; G06F 16/28; H04L 9/0618; G06F 16/243; H04L 9/50

(57) ABSTRACT

Systems and methods are described for automated, user-configurable, unique, hyper personalized and specific to the engagement, objective and/or transaction, rules based human and machine workflow management system. Systems, machine learning, artificial intelligence, and/or natural language processing can be used to identify, review, score, filter, display and categorize various forms of content, communications and collaborations. Human and machine review participants can be automatically provided content for review in a specific subject matter or topic. Distributed ledgers, centralized databases, and/or other computerized machine technologies, can help provide secure attribution and authentication of content as well as management of content review, publishing, editing, collaboration, and compensation contracts.

User-configurable transparent scoring of all human, machine and organizations activities provide basis for communications, engagement, collaboration, compensation and terms.

### RELATED APPLICATIONS

This application is a divisional patent application of U.S. application Ser. No. 17/051,918 filed on Oct. 30, 2020, which is a National Stage Entry of International Application No. PCT/US2019/033125 filed on May 20, 2019, which claims priority to U.S. Provisional Application No. 62/673,495 filed on May 18, 2018, the contents of each of which are hereby incorporated by reference in their entireties.

### TECHNICAL FIELD

The disclosure relates to the automated, configurable discovery, correlation, extension, analysis, scoring, monitoring, searching, discovering, tracking, filtering, collaboration, distribution, hyper-personalization, and display of all types and elements of content and communications with human and/or machine input and collaboration.

### BACKGROUND

The cost and access barriers that used to exist with respect to creation and widespread distribution of content have been erased in today's networked culture. Internet forums, social media sites, messaging applications, individuals, networks, communities, and media sharing sites all offer instant access to potentially millions of users. Furthermore, increasingly capable and affordable computing devices put powerful content creating and editing tools in the hands of average consumers and mobile devices provide constant connectivity and a desire for ever more content to consume.

As the barriers to content creation and distribution crumble, so do the inherent checks on quality, accuracy, authenticity, credibility, relevance, significance, and other content features and/or components. The old adage that if it's on TV it must be true may be tongue in cheek but it must be said that distribution (including wide distribution of viral content and perceived peer endorsement of shared content) and a professional appearance (e.g., realistic photo altering, sponsored content interspersed with legitimate news articles, and official sounding names) inevitably lend credibility to content in the eyes of the masses. Whether it is news, financial research, academic research, conversations, private, public, official, business or any other type of content and/or communications, it is very easy currently to create, publish, present, display, store, hyper-personalize and widely distribute misleading, inaccurate, or wholly untrue content today.

With the ever evolving expansion of data collection, monitoring, storing and analyzing technologies such as 5g and IOT, more and more critical information and data will be available to aid in the widening and deepening correlation, analysis, creation and review of all types of content. However, with this expanding universe of data availability comes the challenge of sifting, discovering, filtering, correlating and analyzing the specific data and information potentially of relevance, significance and value.

Social media sites and other distributors, storers, aggregators, consumers, and publishers of digital and other content and communications are scrambling to find ways of screening a seemingly impossible volume of content to help discover, correlate, analyze, create, identify, rank, display and/or filter content, communications and collaborations, including so called “fake news”, misinformation, and misleading or inaccurate research. However, there are currently no satisfactory means of identifying and scoring content, collaboration and communications, including original misleading or false content or unauthorized alterations to content, communications, collaborations and/or sources. Furthermore, individuals may have lost faith in the distributors and their motives for filtering content to an extent that even well-intentioned self-policing by the distributors will prove ineffective at building trust with the public. This has left consumers, publishers, authors, communities and groups demanding granular, and unique to the specific transaction, engagement or communication, control over their identity and a better means to understand the identity, quality and characteristics of the content, individuals, communities, publishers, platforms and/or groups they may or may not communicate, engage, transact and/or collaborate with.

Additionally, in the wake of the 2008 financial crisis and as a result of subsequent regulation including the Markets in Financial Instruments Directive in Europe, there is increased scrutiny on financial research and the motivations and intentions of the creators of financial research. Similar to the content discussed above, individuals are demanding more information regarding financial research and the sources from which it comes, as well as seeking wider and deeper data points to extend the creation and analysis of financial analysis and information flow

### SUMMARY

The present invention provides systems and methods for the automated and/or configurable analysis, scoring, tracking, filtering and display of all elements and types of content, collaboration and communications, including annotations and comments. Through the use of real-time and continuous dynamic machine and/or human analysis and scoring by relevant subject matter, weighted by a credibility score constantly updated for each human, machine, site or networked source, participant and action, a configurable score or rating can be provided for individual pieces and elements of content based on veracity, quality, comparison to other content, and/or other analysis or metrics. Content can be stored and validated using digital and/or machine contracts. Accordingly, once scored or rated, rules-based systems and methods of the invention can track and validate the content to identify any changes, especially unauthorized edits made by third parties, and update the scoring as required. By scoring and validating content, content creators can control creation and distribution of their content and thereby protect their brand and public image ensuring that misleading or offensive content is not falsely attributed to them, while also supporting the configurable hyper-personalization of content filtering, delivery and display to individuals and/or groups by the publisher, distributor, platform or by individuals, communities, organizations and/or collaborator and consumer.

Methods may use automatic, rules-based and/or configurable machine and human analysis of content, collaboration, communications, content creators, individuals, moderated crowd and communities, other individual and networked sources, all weighted by subject matter credibility and/or other measurement scores using, for example, machine learning, artificial intelligence, natural language processing, distributed ledger and/or other content analysis technologies. Human and machine participants can be rated, linked, weighted, filtered or ranked for both authorship and review of content in one or more subject matter areas. The rating can help inform the scoring of validated content from that individual, crowd, community, network source, site, technology and/or machine. The dynamic score or rating for a piece of content can comprise a rating of the content's author based on the quality, veracity, and/or other features of past content created by that author, participant, publisher, presenter or source. Rating, ranking, indexing, or evaluating of machine and private and public human participants may be accomplished using software tools, data science, statistical analysis or other means for reputation, credibility, credential, associations, experience, and engagement, for example. The user, consumer, group, community and/or participant can configure the rules-based selection and weighting of any or all of the factors used in rankings, filtering and scorings, and all scoring and factors and weighting can be made visible to provide background on how scoring operates.

Content can be queued and/or submitted for scoring, collaboration, filtering, distribution and display including but not limited to automatically by machine as determined, configured by the author, distributor, publisher, community, platform, user/consumer or manually by humans.

Machine analysis can also contribute an initial rating or scoring of content itself that combined with human, crowd and/or community analysis and author and publisher or affiliation analysis, or other individual and or networked source may form a piece of the dynamic rating or scoring.

Furthermore, initial machine analysis of content, communication and collaboration may identify one or more subject matter or other classifications for any piece of content and, matching those classifications to human and other machine participants according to their ranking in that area, can funnel the relevant content to the participant for machine, human, crowd, and/or community configuring, filtering, display, review and rating. Multiple ratings can be combined to form an aggregate score for the content. Human or machine participant enlistment and engagement may be managed through a targeted relevance engine to identify and match reviewers with specific content and communications to review, hyper-personalization and filtering of content and other communications distribution and display, to individual and/or group, propensity to respond and other factors including psychological and behavioral, and then monitor and score engagement, communications, job, task, submission, collaboration, presentation, publication, filtering, display, and workflow processes.

Custom natural language processing, and other machine content analysis methods algorithms may be designed for each field or subject matter area to recognize and analyze content in that area. Machine learning algorithms can be trained on content elements consisting of human and/or machine-verified content and its associated rating or score to identify unseen or previously unknown features common to high quality to true content, and also used to customize processes specific to the audience or objective. Systems and methods of the invention can continually feed analysis data back into the system to further train and improve the machine analysis portion. One contribution of the invention is that, while human screens for truth and quality in content and communications can be overcome by other human authors based on common knowledge of examined features, artificial intelligence is adept at identifying patterns in data that are not recognizable normally under human analysis.

In various embodiments, systems and methods of the invention can be used to rank subject matter credible human, community, machine, and moderated crowd sourced participants for automated and/or configurable submission, creation, hyper-personalization, analysis, research, review, learning, teaching, training, distribution, publication, filtering, display, presentation, communications, workflow, authenticity, augmented collaboration, scoring, rating, ranking, indexing, and other evaluative measurement methods for all types of content, communications, learning, presentations, research, knowledge, collaboration, and business processes, communications and practices.

Systems and methods of the invention can be platform and technology agnostic and therefore able to operate on one or more centralized or decentralized databases and technologies, interfaces, devices, and/or operating system architectures. A customizable analysis platform of the invention may operate in conjunction with an application programming interface to interface with various platforms, services, databases, and operating systems.

Digital and/or machine contracts may be used to allow for configuration and automation of engagement terms for identify, hyper-personalization, participation, teaching, learning, training, access, editing, publishing, distribution, filtering, display, reviewing, collaboration, communications, compensation, and scoring management. Digital and/or machine contracts can also manage immutable storing, ownership, authenticity, credibility, and validation of content and sources. The above digital and/or machine contracts may use immutable decentralized databases (e.g., Blockchain or Distributed Ledger Technology) or centralized databases with, for example, Structured Query Language (SQL) or NoSQL data and other content management to maintain control of verified content and to easily identify unauthorized edits such as Photoshop altering of an image.

Systems and methods may include computing devices comprising a tangible, non-transitory memory storing instructions and a processor operable to execute those instructions to perform the disclosed methods.

In various embodiments, artificial intelligence (AI), natural language processing and generation (NLP and NLG) are used to filter and interpret multiple cycles of search results by automatically initiating subsequent/continuous searches based on the analysis of prior results. The AI can be used to interpret, analyze, and weigh results as well as to define and initiate additional searches. Accordingly, specific content for rules-based notifications to human users and execution of other assets ownership options and strategies can be created and executed automatically.

In certain embodiments, systems and methods of the invention include a rules-based system, driven by AI and NLP, for managing the automated processes that leverage multi-threaded multi-cycled search, and filter to uncover previously unrecognized (newly identified by system) relevant factors that could be separated by multiple degrees and/or correlation from the content or original relevant factors but that correlate to and can potentially extend and/or impact an already recognized relevant factor as an underlying information or data point in support for a stock or any equity or asset evaluation or analysis. Rules based driven human and machine processes can score and rank and/or rate discovered information for relevance and/or significance. Certain embodiments may leverage other emerging technologies and graph based database techniques to discover new data and/or information points that correlate to and extend other research, news or other types of content.

### BRIEF DESCRIPTION OF THE DRAWINGS

FIG. 1 illustrates interactions of various system and method components according to certain embodiments.

FIG. 2 illustrates platform architecture for systems and methods of the invention according to certain embodiments.

FIG. 3 illustrates dynamic rating systems and methods according to certain embodiments.

FIG. 4 illustrates content analysis and human or machine participant matching and enlistment according to certain embodiments.

FIG. 5 shows digital contract structures and uses according to certain embodiments.

FIG. 6 illustrates content storage and management according to certain embodiments.

FIG. 7 shows an exemplary flow chart for a real-time scoring platform with credibility quotient scoring.

FIG. 8 shows an exemplary flow chart for real-time component monitoring and updating for financial research.

FIG. 9 shows an exemplary interface for Relevant Factor review and rating.

FIG. 10 shows a system creating, sharing, reviewing, and rating content according to certain embodiments.

FIG. 11 gives a schematic of components that may appear within a system of the invention according to various embodiments.

FIG. 12 provides an exemplar overview of content analysis systems according to certain embodiments.

FIG. 13 provides an exemplary data ingestion pipeline according to certain embodiments.

FIG. 14 provides exemplary data sources according to certain embodiments.

FIG. 15 illustrates exemplary data intake and storage processes according to certain embodiments.

FIG. 16 illustrates exemplary NLP processing of data according to certain embodiments.

FIG. 17 provides an exemplary graphical representation of relationships among relevant factors, keywords, and pieces of content.

FIG. 18 shows an overview of an exemplary rules-based AI/NLP powered relevant factor index.

FIG. 19 shows exemplary company coverage activation according to certain embodiments.

FIG. 20 shows an exemplary information pipeline according to certain embodiments.

FIG. 21 shows exemplary initial company relevant factor data parsing and NLP flow.

FIG. 22 shows an exemplary NLP analysis of relevant factors for a company.

FIG. 23 shows an exemplary search term extraction.

FIG. 24 shows an exemplary identification and ranking of related terms to construct a search query.

FIG. 25 shows an exemplary graph database for storing terms and their relationships.

FIG. 26 shows an exemplary user interface for relevant factor index interaction.

FIG. 27 shows exemplary relevant factor index scoring.

### DETAILED DESCRIPTION

Systems and methods of the invention provide rules-based automated and configurable analysis, rating, filtering, searching, discovery, display and tracking of content, learning, research, knowledge, communications, collaboration, presentations and business processes and practices. The embodiments described herein have applications in academic and financial research as well as news creation and distribution, reporting, business communications, legal and government processes, education, learning and workflow and many other areas. Using a rules-based, real-time and/or continuous dynamic analysis by subject matter rated by credibility, human and machine processes, identified and assigned by a targeted relevance engine, a score or rating can be provided for all components of individual or aggregated of pieces of content, collaboration and communications for quality and accuracy among other features. Digital and/or machine contracts held in immutable decentralized databases or on secure centralized databases can track content and configuration changes and facilitate hyper-personalized participant engagement, ratings, identity, teaching, learning, training, access, editing, publishing, reviewing, collaboration, filtering, display and compensation.

Accordingly, systems and methods of the invention can provide an independent, third party tool for providing creators, publishers, presenters, communities, groups, distributors, managers, collaborators and consumers of content and communications of any type with verified ratings, thereby instilling confidence and a reality check in the era of widespread cheap media distribution by anyone with a camera phone and/or a computer.

Content to be reviewed, analyzed, scored, and/or rated using the systems and methods described herein may include, for example, images, videos, text, audio, comments, meetings, collaborations, communications, presentations, augmented and/or virtual reality experiences, and portions or combinations of any of the above.

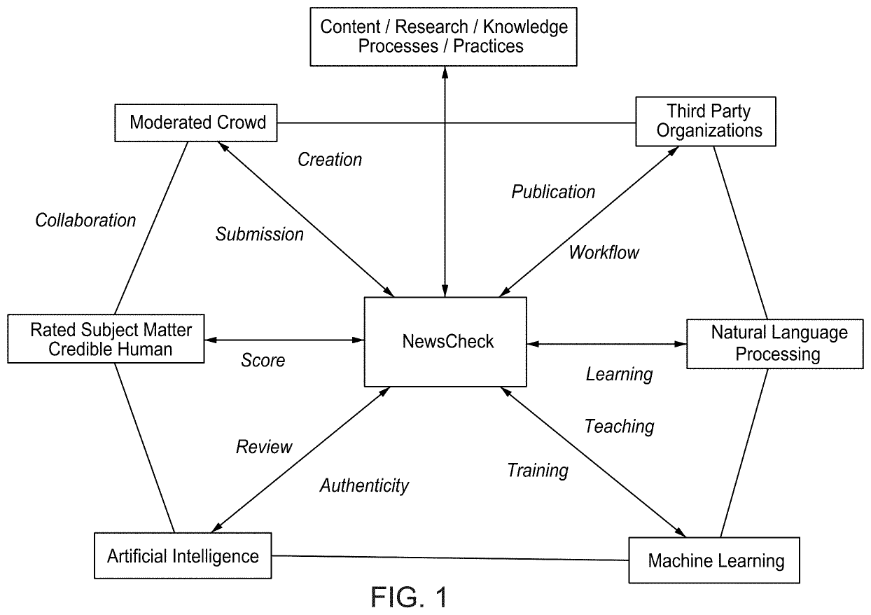

FIG. 1 provides an overview of the systems and methods of the invention as exemplarily applied to news content. A news-based review and scoring system, here labeled NewsCheck receives content, research, knowledge, processes, and/or practices from outside sources such as individual contributors, consumers or third party organizations providing and/or seeking validation, scoring and control for their content and communications either by automated or manual queueing. In various embodiments, systems may be used by the end consumer to, for example, scan their social media news feed or other content sources to rate, filter and display content and communications. In such instances, content may enter the system from an automated machine queue or human participant or consumer. Initial analysis of the content can be conducted using machine analysis such as natural language processing customized for specific applications (e.g., for news generally or for specific subsets of news such as news for a certain region or of a certain type). Such an initial analysis can provide multiple outputs including a preliminary ranking or score for various parameters such as accuracy or credibility. Another output may include identification of subject matter topics in the content and matching sections of the content with one or more specific human or machine reviewers having a threshold rating in that subject matter. Scores for the content from one or more human or machine reviews can be configured and then compiled to provide a rating or score for the content which can then be configured and/or filtered for display distribution, publishing, consuming, and/or delivery to a third or multiple parties.

Human and/or machine reviewers may be retained or queued as on-call reviewers and/or may be crowd sourced in real-time. In certain embodiments reviewers may be enlisted with minimal subject-matter vetting where a large quantity of reviewers may compensate for a lack of specific subject matter ratings. In all cases, transparency as to what and how factors are weighted and scored may be available for all users and participants. Users and participants can configure factors and weightings to achieve any specific objective, including filtering, distribution, presentation, display and hyper-personalization. The configurability and visibility/transparency of factors and weighting behind various ratings or scores for content provide confidence and trust by the consuming public as well as participants such as reviewers, creators, authors, consumers, communities, organizations and/or collaborators. Factors may be obtained from third-party sources including individuals, sites, organizations, or institutions and those sources can also be scored or rated for credibility or other features such that the factors obtained therefrom may be weighted according to the credibility of the source and as configured by the user or group.

In various aspects of the invention including, for example, subject matter identification, content analysis, and participant rating, machine and human learning methods may be used to identify patterns indicative of content features (e.g., relation to a specific subject matter, participant credibility, or content quality or accuracy).

Any machine learning algorithm may be used for the systems and methods described herein including, for example, a random forest, a support vector machine (SVM), or a boosting algorithm (e.g., adaptive boosting (AdaBoost), gradient boost method (GSM), or extreme gradient boost methods (XGBoost)), or neural networks such as H2O. Machine learning algorithms generally are of one of the following types: (1) bagging, (2) boosting, or (3) stacking. In bagging, multiple prediction models (generally of the same type) are constructed from subsets of classification data (classes and features) and then combined into a single classifier. Random Forest classifiers are of this type. In boosting, an initial prediction model is iteratively improved by examining prediction errors. Adaboost.M1 and eXtreme Gradient Boosting are of this type. In stacking models, multiple prediction models (generally of different types) are combined to form the final classifier. These methods are called ensemble methods. The fundamental or starting methods in the ensemble methods are often decision trees. Decision trees are non-parametric supervised learning methods that use simple decision rules to infer the classification from the features in the data. They have some advantages in that they are simple to understand and can be visualized as a tree starting at the root (usually a single node) and repeatedly branch to the leaves (multiple nodes) that are associated with the classification.

Random forests use decision tree learning, where a model is built that predicts the value of a target variable based on several input variables. Decision trees can generally be divided into two types. In classification trees, target variables take a finite set of values, or classes, whereas in regression trees, the target variable can take continuous values, such as real numbers. Examples of decision tree learning include classification trees, regression trees, boosted trees, bootstrap aggregated trees, random forests, and rotation forests. In decision trees, decisions are made sequentially at a series of nodes, which correspond to input variables. Random forests include multiple decision trees to improve the accuracy of predictions. See Breiman, L. Random Forests, Machine Learning 45:5-32 (2001), incorporated herein by reference. In random forests, bootstrap aggregating or bagging is used to average predictions by multiple trees that are given different sets of training data. In addition, a random subset of features is selected at each split in the learning process, which reduces spurious correlations that can result from the presence of individual features that are strong predictors for the response variable.

SVMs can be used for classification and regression. When used for classification of new data into one of two categories, such as having a disease or not having a disease, a SVM creates a hyperplane in multidimensional space that separates data points into one category or the other. Although the original problem may be expressed in terms that require only finite dimensional space, linear separation of data between categories may not be possible in finite dimensional space. Consequently, multidimensional space is selected to allow construction of hyperplanes that afford clean separation of data points. See Press, W. H. et al., Section 16.5. Support Vector Machines. Numerical Recipes: The Art of Scientific Computing (3rd ed.). New York: Cambridge University (2007), incorporated herein by reference. SVMs can also be used in support vector clustering. See Ben-Hur, A., et al., (2001), Support Vector Clustering, Journal of Machine Learning Research, 2:125-137.

Boosting algorithms are machine learning ensemble meta-algorithms for reducing bias and variance. Boosting is focused on turning weak learners into strong learners where a weak learner is defined to be a classifier which is only slightly correlated with the true classification while a strong learner is a classifier that is well-correlated with the true classification. Boosting algorithms consist of iteratively learning weak classifiers with respect to a distribution and adding them to a final strong classifier. The added classifiers are typically weighted in based on their accuracy. Boosting algorithms include AdaBoost, gradient boosting, and XGBoost. Freund, Yoav; Schapire, Robert E. (1997). “A decision-theoretic generalization of on-line learning and an application to boosting”. Journal of Computer and System Sciences. 55: 119; S. A. Solla and T. K. Leen and K. Muller. Advances in Neural Information Processing Systems 12. MIT Press. pp. 512-518; Tianqi Chen and Carlos Guestrin. XGBoost: A Scalable Tree Boosting System. In 22nd SIGKDD Conference on Knowledge Discovery and Data Mining, 2016; the contents of each of which are incorporated herein by reference.

Machine learning algorithms can be trained on data sets useful for the intended purpose of the machine analysis. For example, to train for machine analysis of content for a specific feature such as accuracy in a news article, a machine learning algorithm can be provided with a training data set including a number of articles along with corresponding accuracy ratings made by human experts. The algorithm can then identify common patterns in the articles (e.g., the use of certain words, misspelling, or length of sentences, paragraphs, or the entire piece) having a certain characteristic or rating. A particular advantage of machine learning algorithms is the ability to identify patterns that cannot be easily perceived by human analysis. This makes it more difficult for any analysis systems of the invention to be manipulated by purveyors of false content. The above example is an illustration of the concept and machine learning algorithms may be trained on data sets to find patterns indicative of a certain content creator or certain qualities (desirable or otherwise) in content, content creators, or potential review participants for example.

In certain embodiments, systems and methods of the invention can be used for content creation, filtering, distribution and display. For example, content and other communication features determined to be relevant to or indicative of certain desirable characteristics (e.g., honesty, quality, popularity, topic, source, etc.) can be determined as described herein and then used to create, distribute and display content and other communications that includes those features and is therefore perceived to have the desirable characteristics. Analysis methods may also be used as a pre-publishing review tool to evaluate drafts of content before distribution. Contributor and/or reviewer subject matter ratings as described herein may also be used to find collaborators or identify and recruit content creators or authors for various subjects or pieces of content.

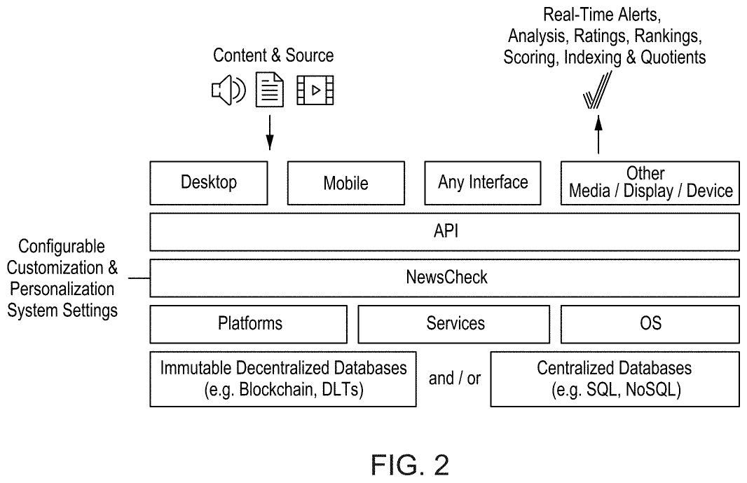

FIG. 2 illustrates platform architecture according to certain embodiments. Systems and methods are designed to be platform and technology agnostic so that they can sit on a variety of databases and interfaces to obtain, analyze, score, and distribute content. As shown in FIG. 2, content and sources can be obtained from and sent to computing devices (e.g., desktop or mobile computers and devices) or end output devices such as displays or audio devices via an application programming interface (API). The analysis suite, shown here as a news-specific system called NewsCheck, provides a customizable system for analyzing received content as well as access, via various platforms, services, and operating systems, to secure data storage to be used for storing and preventing manipulation of digital or machine contracts as described below. Such databases can include immutable decentralized databases (e.g., Blockchain or DLTs) or a secure centralized database.

An important component of the systems and methods of the invention is the ability to configure and dynamically rate content, content creators, sources, communications, publishers and content review participants. All review data can be consistently provided back to the machine learning or other analysis systems in a feedback mechanism to update and hone the ratings and systems. Accordingly, all machine analyses should improve through time and use with an end result of perhaps supplanting the need for human review.

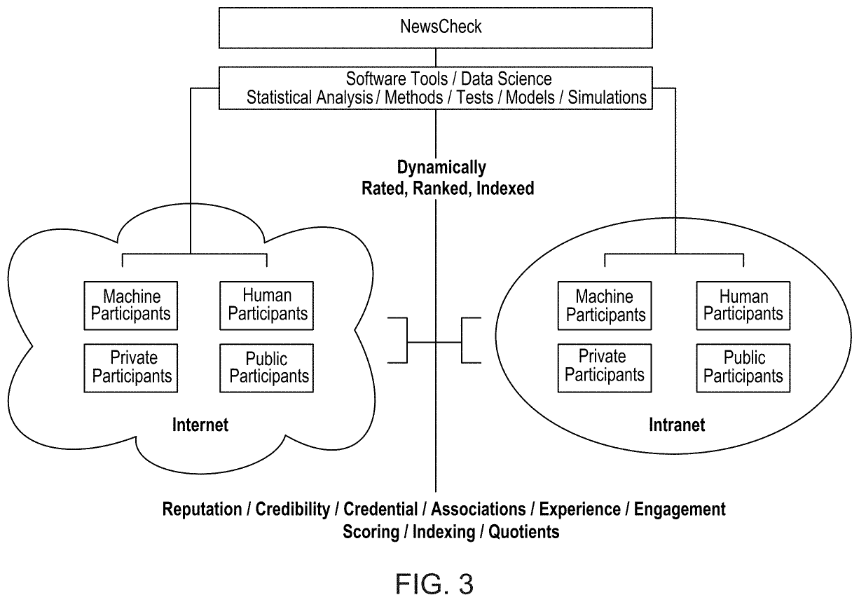

FIG. 3 illustrates dynamic rating systems and methods for human and machine review participants. Participants can be private or public and can be networked to the system via internet or intranet networks. Software tools, data science, statistical analysis, methods, tests, models, and/or simulations may be used to dynamically rate participants for qualities such as reputation, credibility, credential, associations, experience, engagement, scoring, indexing, and/or quotients.

Content ratings may be weighted according to the participant providing the rating (e.g., a positive score from a review participant that is rated highly in the relevant subject matter area will have a greater effect on final content ratings than a similar score from a participant that is less highly rated in that area). Content factors and weighting may be customized or configured by individual users or groups thereof as part of the creation and review process.

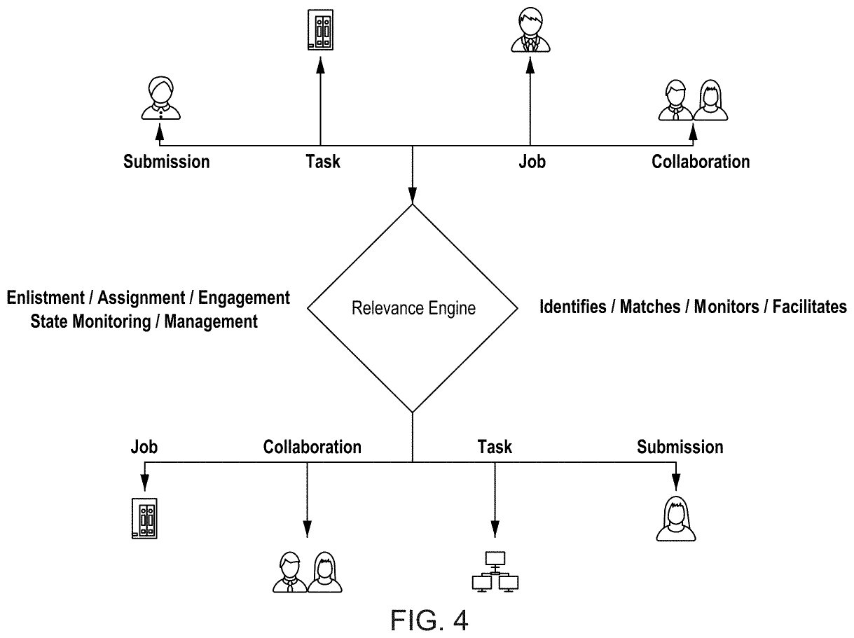

FIG. 4 illustrates content analysis and human or machine participant matching and enlistment. A major contribution of various embodiments is the ability to automatically, in real-time, identify one or more subject matter areas for a piece of content and to match the content with machine and/or human review participants according to competence in those areas. As shown in FIG. 4, a relevance engine may be used to perform the identification and matching steps. The relevance engine may comprise a machine learning algorithm trained to identify patterns in content that relate to various subject matter areas so that machine analysis can subsequently provide quick and accurate content sorting. The relevance engine can identify, match, monitor, or facilitate several functions. For example, the relevance engine can be used for content submission and enlistment, assignment, engagement, state monitoring or management of content submission for review or collaboration by quickly matching participants with material and/or task.

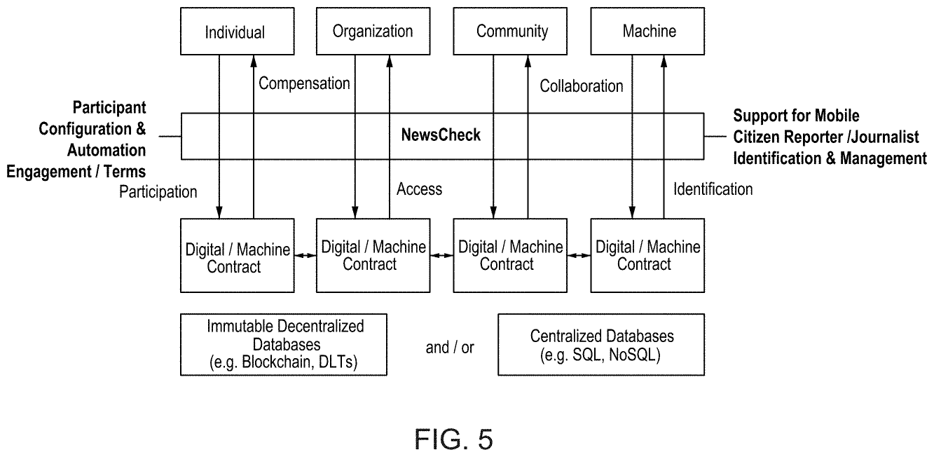

FIG. 5 shows digital contract structures and uses according to certain embodiments. As noted earlier, an important aspect of various embodiments is the ability to securely maintain databases with content-relevant information. Such information can include managing, through digital and/or machine contracts for managing and automation of all engagement and terms for identity, participation, teaching, learning, training, access, editing, publishing, reviewing, collaboration, filtering, display, presentation, compensation and scoring management as described herein.

Such contracts can include support for mobile Citizen Reporter/Journalist identification and management of content access, compensation and collaboration. Accordingly, many of the drawbacks of open access reporting (e.g., lack of accountability and verification of facts) can be addressed. Systems and methods of the invention allow for independent assessment of content from both established outlets and individual contributors as described above. Furthermore, while brand policing and identity management may be regularly addressed by, for example, major news outlets the digital contract structure described herein can allow for individual citizen reporters or other contributors to protect their identity and to thereby build their personal brand recognition and trust with content consumers without the risk of imposters usurping their name or content. The platform, shown as the news-based NewsCheck in the exemplary embodiment of FIG. 5, can manage the digital contracts for individuals, organizations, communities, and machines whether they be review participants, content creators, or content consumers. The digital contracts, stored on immutable decentralized databases or secure centralized databases provide a verifiable catalog of the identity, competencies, tasks (review, editing, publishing, collaboration, teaching, learning, consuming), and can track and automatically manage tasked-based compensation upon completion or per other recorded agreements. Digital contract management can be configured and automated by the responsible parties.

Both the above-described digital contracts relating to engagement and terms as well as the digital and/or machine contracts for content management described below can be securely stored in, for example, immutable decentralized databases such as Blockchain or distributed ledger technology (DLT).

Blockchain provides a cryptographically secured list of records including a cryptographic hash of the previous block, a timestamp, and transaction data. As used in the present invention, Blockchain can provide a secure description of original content, participant (e.g., reviewer, contributor, or consumer) identity and competencies, relevant compensation information, or any other features described herein along with a catalog and date stamp of each edit made to the initial data. For example the Blockchain can provide a secure record of the last authorized edit made to a piece of content and can therefore allow for the identification of unauthorized edits or attempts to corrupt the message of the content for anterior purposes (e.g., image alteration or false attribution to an author).

DLT (of which Blockchain is a specific example) comprises a series of distributed synchronized copies of replicated data where the security lies in the fact that no central authority maintains the ledger or data and so, data cannot be corrupted at a single point.

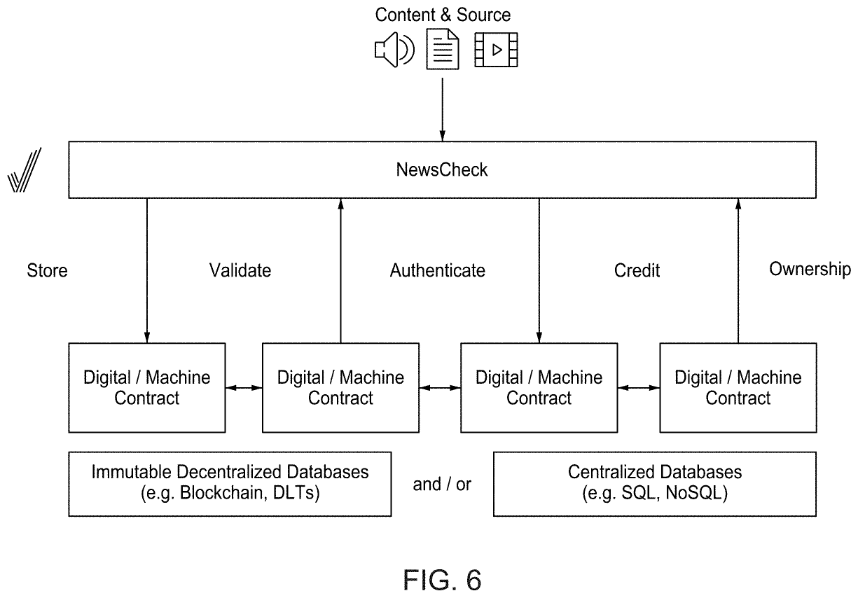

FIG. 6 illustrates content storage and management according to certain embodiments. As noted earlier, secure data storage can help to record pieces of content themselves and then referenced to validate and authenticate copies for end consumers to verify that they are viewing the original content with verified attribution to a specific creator. Accordingly, creation and ownership credit can be recorded in such databases as well to ensure that those features are accurately tracked and reported with any distributed content.

In certain embodiments, systems and methods of the invention may be applied to financial research. Any combination of the artificial intelligence, natural language processing, and human review procedures described above can be applied to financial research to categorize, monitor, identify, search, discover, score, rank and update discreet Relevant Factors (RF) of research content. Relevant Factors can include, for example, facts, opinions, assumptions, or predictions identified in a piece of financial research or other content that can be recognized, identified or designated by human and/or machine input and/or processes as a Relevant Factor. In an exemplary embodiment, each sentence in a data source such as a stock evaluation represents a single relevant factor for further analysis.

Relevant Factors may include previously-recognized relevant factors, previously-unrecognized relevant factors that are subsequently recognized within the industry and/or community (PURFS), and still unrecognized relevant factors (SURF) that are still not recognized within the community and/or industry.

Configurable NLP, AI and automated internet processes can be deployed to monitor and filter market data (e.g., price and trade related data for financial instruments such as equities, fixed-income products, derivatives, and currencies) news and other information from any print or digital financial reporting services or other general and/or on-line sources to identify data points that impact or reveal RF correlations. Real-time, rules-based alerts can be leveraged to communicate and solicit feedback on RF's via internal/vendor, external, and social media network collaboration. The Relevant Factors and review mechanisms (human or machine) can be weighted and those weightings can be dynamically adjusted or prompt recommended changes to be communicated to content hosts or authors.

External or internal review networks (e.g., credibility-validated networks (CVNs)) can be developed and leveraged to provide category-specific expert analysis of content or individual Relevant Factors identified therein. Credibility Quotient (CQ) scoring of the RF's can be used to provide content creation firms a scientific method to highlight, price and sell their content. For example, a content creation firm (e.g., a financial research company) can highlight their independent credibility rating as determined through methods described herein for all content or content by categories in order to support a higher price for their content.

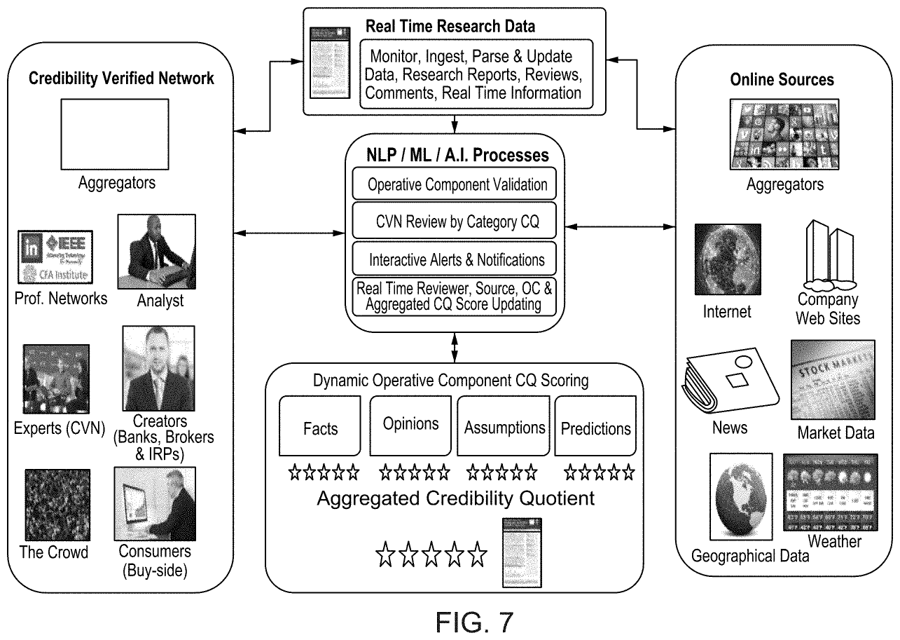

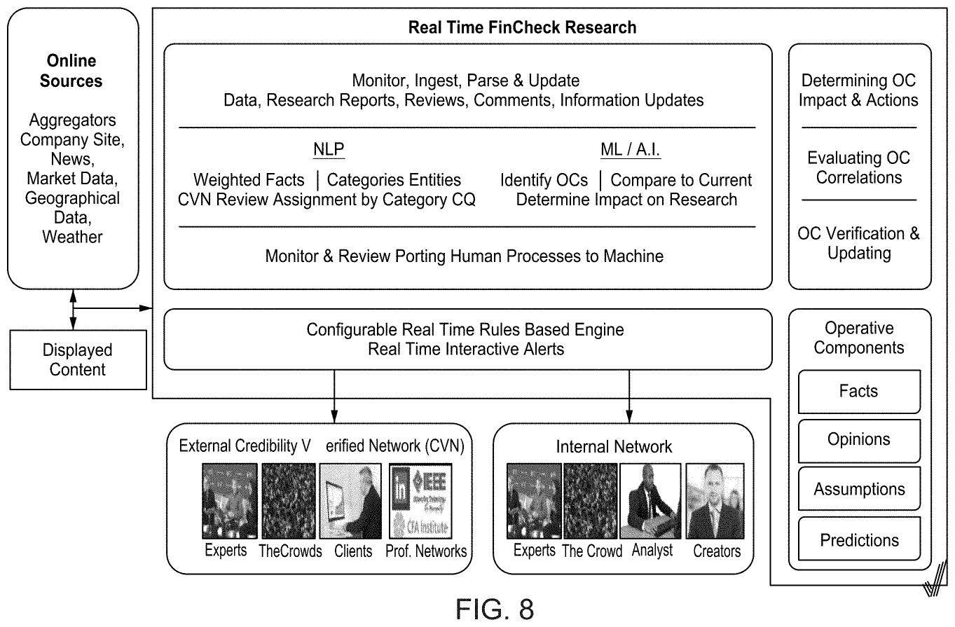

Relevant Factors and their scores can be aggregated into an overall Credibility Quotient ranking and updated in real time as additional reviews and/or online data sources impact RF scoring. FIG. 7 is an exemplary flow chart of systems and methods of the invention featuring dynamic RF scoring. RFs and Aggregated Credibility Quotient Scoring can change in real-time as assumptions become validated and predictions become actualized. FIG. 8 illustrates an exemplary system for real-time monitoring and updating of Relevant Factors in financial research. Financial and other information is collected or received from a variety of sources (e.g., culled from internet sites, aggregators, company sites, e-mail, or print publications) and can include company information, financial news, market data, as well as general news, geographical data or even data points such as weather. Systems and methods of the invention monitor, ingest, parse, and update the received data, research reports, reviews, comments, and information. Machine learning and artificial intelligence analysis of the data identify Relevant Factors and/or other information that may be Relevant Factors or impact Existing Relevant Factors in the data, compare to current information, and determine an impact on a given piece of financial research, Relevant Factor or displayed content (e.g., a report on a company hosted by a financial reporting or research firm). Natural language processing (NLP) analysis of the received data can be used to identify weighted facts, categories, and entities. The initial NLP, Al, and ML analyses can inform review assignments for and categorization of data before funneling the data to machine review or a human network of experts in the identified categories. External review networks consisting of experts, crowd-based analysis, clients, or professional organizations with expertise in the relevant area can be used to review and rank data or internal networks of analysis, content creators, or experts can be used. Data can be directed to any number of the above reviewing bodies for analysis for accuracy, verification, updating, and evaluation. The reviewed data can then be used to determine impact on relevant financial research (e.g., an information summary for a potential investment) and, if warranted, to update that content and display the updated content.

In various embodiments, automated processes are used to leverage multi-threaded search, filter, NLP and AI to uncover, score, and rank new relevant factors that may have multiple degrees of separation from but that correlate to and can potentially extend and/or impact an already recognized relevant factor. For example a certain weather pattern or seemingly un-related world events may be found to correlate to and impact an industry recognized relevant factor (e.g., P/E ratio) in analyzing a stock or any equity or asset evaluation. Also leveraging other emerging technologies and graph based database techniques, the system can discover new data and/or information points that correlate to and/or extend and/or widen and deepen other research, news and/or any other type of content piece development, publication, and/or collaboration.

In the case of financial research, the output (e.g., the displayed content) may comprise a recommendation such as a recommended action to be taken (e.g., sell or buy a stock) or to set a target price for a financial instrument. Automated on-line search and filtering, NLP and ML analysis results can be used to compare and validate supporting factors and recommendations. Recommendations can be researched and vetted before being published and supporting factors can be identified and automatically searched.

Other sources such as news and research outlets, and social media, can be reviewed to pull in supporting or conflicting information for a recommendation. For example, geographical information (e.g., is the company in a region that is now in a civil war) or market landscape data (e.g., is there a new company opening in the industry that will compete with this one) can be accessed and analyzed. That supporting or conflicting content, once solicited and received, can be analyzed using the same NLP and ML tools discussed above to capture confidence ratings on that information as well.

In various embodiments, financial information can be combined with the news or other verification and review methods described herein to supplement or fill in missing information or ratings of information. Current market values may be used to compare to past recommendations to rate how credible the recommendation was and can be analyzed using the ML or AI tools to identify correlations between various data points and market value in order to modify and inform data points to look for in future analysis.

Rules-based, real-time or periodic, scheduled monitoring of news feeds or other review systems can be used to find supporting data for or against recommendations in order to constantly or periodically evaluate and update those recommendations based on changes in the data. Push notifications and other alert processes can then be used to inform registered users of changes in recommendations or confidence of supporting factors and recommendations. In certain embodiments, market trading platforms may be integrated into the analysis suite such that users, upon receiving recommendations, can opt to take actions such as submitting trades to buy or sell.

In some embodiments, information and correlations determined using the above analyses can be marketed to not only traders but to provide feedback to financial analysts to review methods and processes they use for putting recommendations together and validating their research. Furthermore, determined recommendations and correlations, which may or may not be ranked for factors such as relevance and significance, can be used to offer feedback to companies or managers of financial instruments by contacting company experts/researchers and offering information on how they can influence supporting factors and recommendations in future.

Previous Relevant Factors can be compared to current supporting factors/recommendations on a number of points. For example, comparisons can focus on how the supporting factors have changed, how certain information creates new Relevant Factors and/or correlates and impacts existing Relevant Factors what was added, what was removed, how were scores changed, and what conclusions can be drawn. The potential impact on the recommendation and to what magnitude or degree can also be determined. Importantly, the dynamic aspects of the invention allow for continuous monitoring of changing facts and user feedback captured in previous steps for validating and updating recommendations. Accordingly, financial or other reporting and recommendations improve over time and more information is digested and more correlations are identified, scored and ranked through continued analysis of the data and results.

Dynamic analysis of data can include weighting based on the expected impact of a Relevant Factor to a recommendation as well as the review (machine or human) based credibility assigned to that Relevant Factor. In other words a discrete RF can be analyzed to determine what effect it may have, if true, on a share price of a company's stock and further analyzed to determine a confidence level that the RF is true and those evaluations can be combined to make a recommendation or change to an existing recommendation. Furthermore, the credibility analysis can be weighted based on tracked credibility or expertise ratings of the reviewing entity (machine or human) based on past performance, peer ratings, or other metrics.

Pre- or post-publication supporting factors and recommendations that have been determined, received, reviewed, or published, can then be reviewed and analyzed by collaborative human/machine systems. Using the systems and methods described herein, confidence can be given to the supporting factors and recommendations and then weighted overall using default settings or user configurable options.

In certain embodiments, review can be conducted by humans. Registered users can be assigned supporting factors and/or recommendations to review and score on selected criteria (i.e., accuracy, factual claims, and credibility of sources, etc.). Users can be financial analysts, supporting factor/recommendation reviewers and submitters or any/all of the three. Users may be assigned based on criteria such as Credibility Quotient, expertise in related categories, dedication (e.g., longevity with the review platform, reliability and timeliness of work product), etc. User's scoring can be reviewed and a Participant Credibility Quotient given. The higher the Participant Credibility Quotient, the higher their review is weighted (by default) into the credibility of a supporting factor/recommendation. Weight of ratings can be configured by users when reviewing reports or can be automatically accounted for in machine compilations of recommendations based on weighted input data. In certain embodiments, human reviewers may be provided compensation.

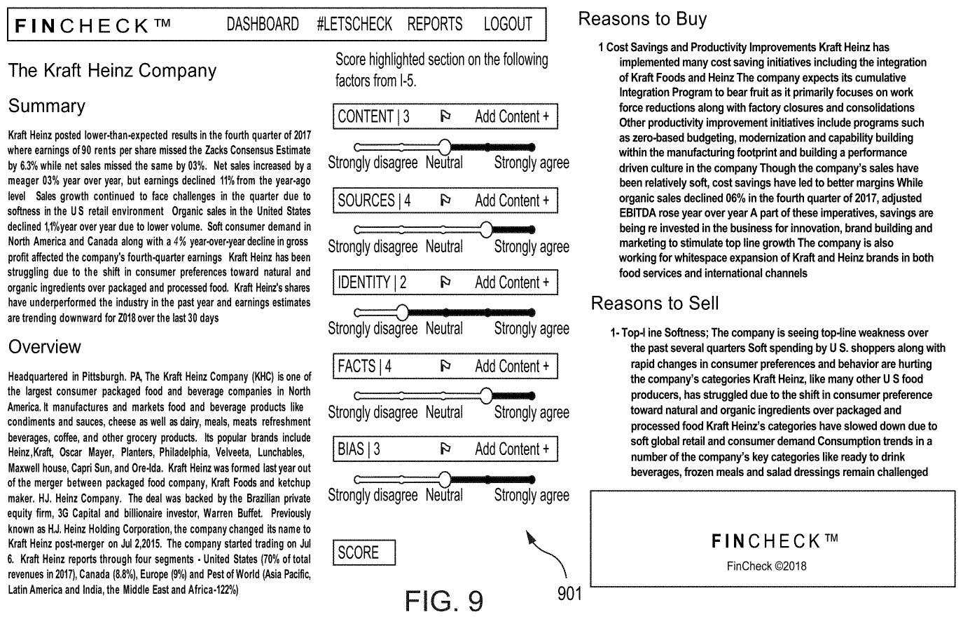

As noted, human review can be by retained experts or can be crowd sourced. In either scenario, reviews may be submitted via a user interface such as a plug-in layered in a browser, directly via a website, by voice command, by mobile application and other information interfaces. For example, as illustrated in FIG. 9, as a human user reviews a piece of content in a web browser or via file reading software (e.g., a.pdf, or Word document), a plug-in may introduce an input interface layered over the content. The interface may highlight or otherwise indicate a particular portion of the content (e.g., a sentence or a chart in a report) and may provide an input mechanism for evaluating that portion of content. In FIG. 9, slidable scales are provided for rating the content section based on five factors (content, sources, identity, facts, and bias) with each factor having a weighting mechanism provided by the slidable scale (e.g., ranging from strongly agree to strongly disagree). A reviewer (retained expert or crowd-sourced participant) can proceed through the content and provide their ratings for any RFs identified therein. In certain embodiments, the RFs (e.g., a graph or sentence) may be automatically identified by a program and an associated rating interface may prompt a review while in some embodiments, a reviewer may self-select various RFs (e.g., through highlighting text with a mouse, touchscreen or other input device) and provide review information for that RF through an interface prompted by their selection of the RF.

Machine review can also be used to evaluate data. NLP may be used to extract information about supporting factors and recommendations, such as sentiment, entities and keywords (i.e., Location—US, Food Services, etc.), and categories of the data and RFs therein. Machine learning (ML) can be used to determine factual vs opinion statements within received data. Confidence scores returned from those NLP and ML processes can be captured. Those confidence scores indicate how well the machine processes think the extracted information relates to and/or how significant or relevant it can be to the input given.

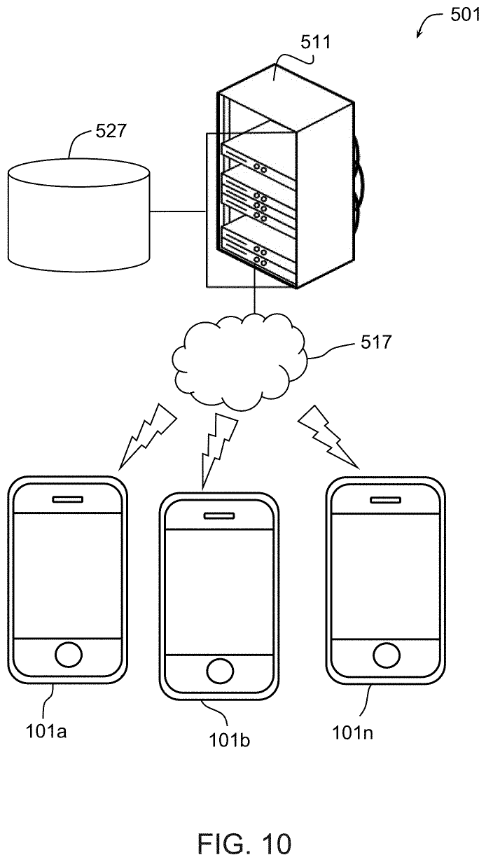

In certain aspects, content systems and methods of the invention may be executed using one or more computing devices connected via a communication network. Content and reviewer ratings and scores, and digital or machine contract information may be created, stored, analyzed, and shared using a system comprising components as shown in FIG. 10 including computing devices 101 (e.g., a mobile device such as a smart phone or tablet or a computer), a communication network 517 (e.g., internet or intranet), and servers 511 where, for example, centralized databases and original copies of content may be stored. An exemplary server 511 implemented system 501 of the invention is depicted in FIG. 7 wherein multiple computing devices 101a, 101b . . . 101n, including a server 511 with a data storage device 527, are coupled to a communication network 511 through which they may exchange data.

According to certain systems and methods of the invention, content transferred among computing devices 101, including servers 511, may be compressed and/or encrypted using a variety of methods known in the art including, for example, the Advanced Encryption Standard (AES) specification and lossless or lossy data compression methods. Servers 511 according to the invention can refer to a computing device 101 including a tangible, non-transitory memory coupled to a processor and may be coupled to a communication network 517, or may include, for example, Amazon Web Services, cloud storage, or other computer-readable storage. A communication network 517 may include a local area network, a wide area network, or a mobile telecommunications network.

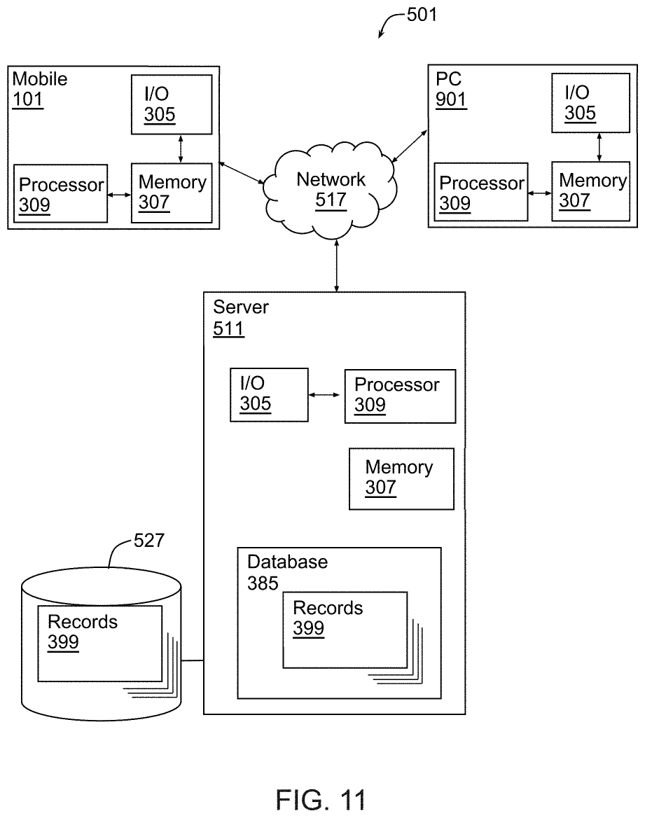

In an embodiment as illustrated in FIG. 11, computing devices 101 according to the invention may provide a content creators and reviewers with an intuitive graphical user interface (GUI). FIG. 11 gives a more detailed schematic of components that may appear within system 501. System 501 preferably includes at least one server computer system 511 operable to communicate with at least one computing device 101a, 101b via a communication network 517. Sever 511 may be provided with a database 385 (e.g., partially or wholly within memory 307, storage 527, both, or other) for storing records 399 including, for example, content, user profiles, and/or scores or ratings of either. Optionally, storage 527 may be associated with system 501. A server 511 or computing device 101 according to systems and methods of the invention generally includes at least one processor 309 coupled to a memory 307 via a bus and input or output devices 305.

As one skilled in the art would recognize as necessary or best-suited for the systems and methods of the invention, systems and methods of the invention include one or more servers 511 and/or computing devices 101 that may include one or more of processor 309 (e.g., a central processing unit (CPU), a graphics processing unit (GPU), etc.), computer-readable storage device 307 (e.g., main memory, static memory, etc.), or combinations thereof which communicate with each other via a bus.

A processor 309 may include any suitable processor known in the art, such as the processor sold under the trademark Core by Intel (Santa Clara, CA) or the processor sold under the trademark Ryzen by AMD (Sunnyvale, CA).

Memory 307 preferably includes at least one tangible, non-transitory medium capable of storing: one or more sets of instructions executable to cause the system to perform functions described herein (e.g., software embodying any methodology or function found herein); data (e.g., portions of the tangible medium newly re-arranged to represent real world physical objects of interest accessible as, for example, content including images or text for news articles); or both. While the computer-readable storage device can in an exemplary embodiment be a single medium, the term “computer-readable storage device” should be taken to include a single medium or multiple media (e.g., a centralized or distributed database, and/or associated caches and servers) that store the instructions or data. The term “computer-readable storage device” shall accordingly be taken to include, without limit, solid-state memories (e.g., subscriber identity module (SIM) card, secure digital card (SD card), micro SD card, or solid-state drive (SSD)), optical and magnetic media, hard drives, disk drives, and any other tangible storage media.

Any suitable services can be used for storage 527 such as, for example, Amazon Web Services, memory 307 of server 511, cloud storage, another server, or other computer-readable storage. Cloud storage may refer to a data storage scheme wherein data is stored in logical pools and the physical storage may span across multiple servers and multiple locations. Storage 527 may be owned and managed by a hosting company. Preferably, storage 527 is used to store records 399 as needed to perform and support operations described herein.

Input/output devices 305 according to the invention may include one or more of a video display unit (e.g., a liquid crystal display (LCD) or a cathode ray tube (CRT) monitor), an alphanumeric input device (e.g., a keyboard), a cursor control device (e.g., a mouse or trackpad), a disk drive unit, a signal generation device (e.g., a speaker), a touchscreen, a button, an accelerometer, a microphone, a cellular radio frequency antenna, a network interface device, which can be, for example, a network interface card (NIC), Wi-Fi card, or cellular modem, or any combination thereof.

One of skill in the art will recognize that any suitable development environment or programming language may be employed to allow the operability described herein for various systems and methods of the invention.

As used herein, the word “or” means “and or”, sometimes seen or referred to as “and/or”, unless indicated otherwise.

### EXAMPLES

### Example 1—Stock Analysis Case Study

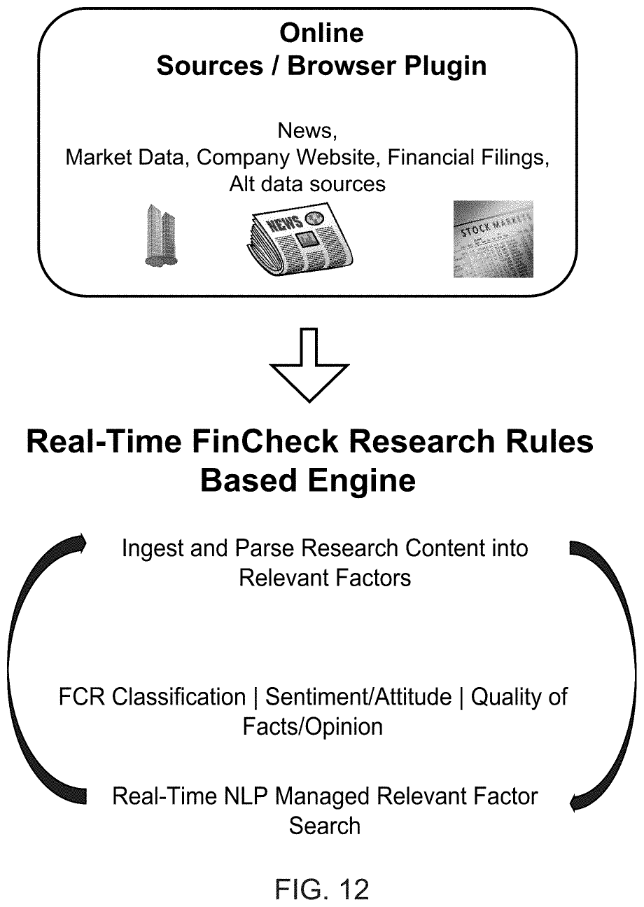

An exemplary application of the disclosed techniques is described herein with respect to financial information and stock analysis. The process is summarized in FIG. 12, showing material from online sources (e.g., provided by a browser plugin) being fed into the financial rules-based engine. Online material may include market data, information from the website of the company being analyzed, financial filings for the company being analyzed, and alternative data sources (e.g., news sites, weather information). The data is analyzed and parsed into relevant factors as described above. The data is subjected to iterative qualitative analyses and NLP searching for relevant factors.

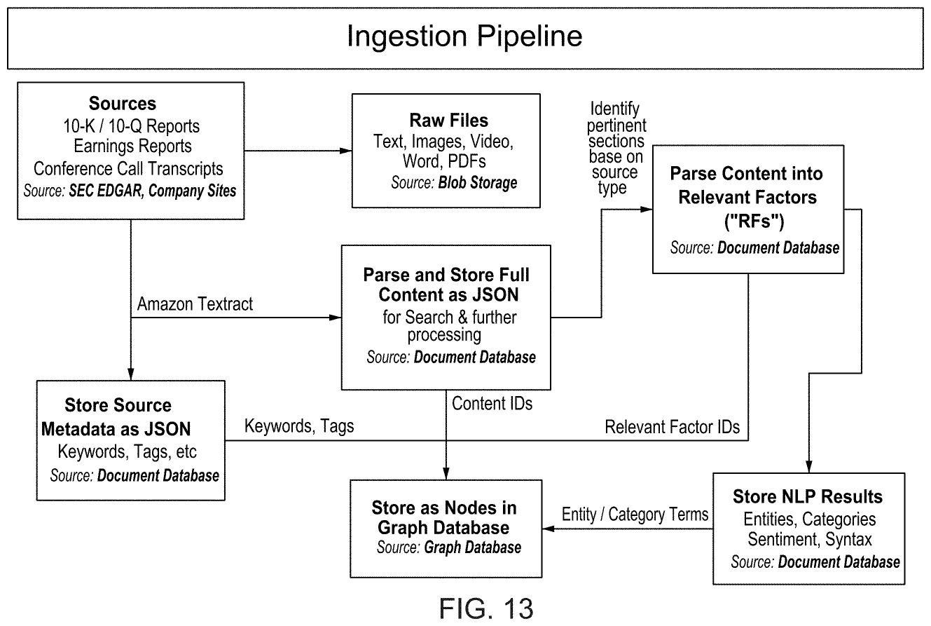

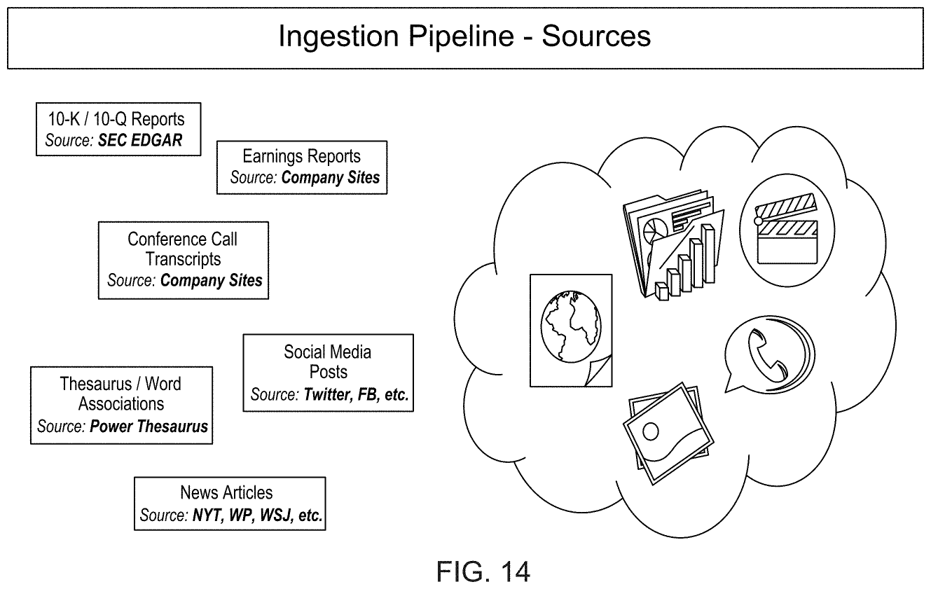

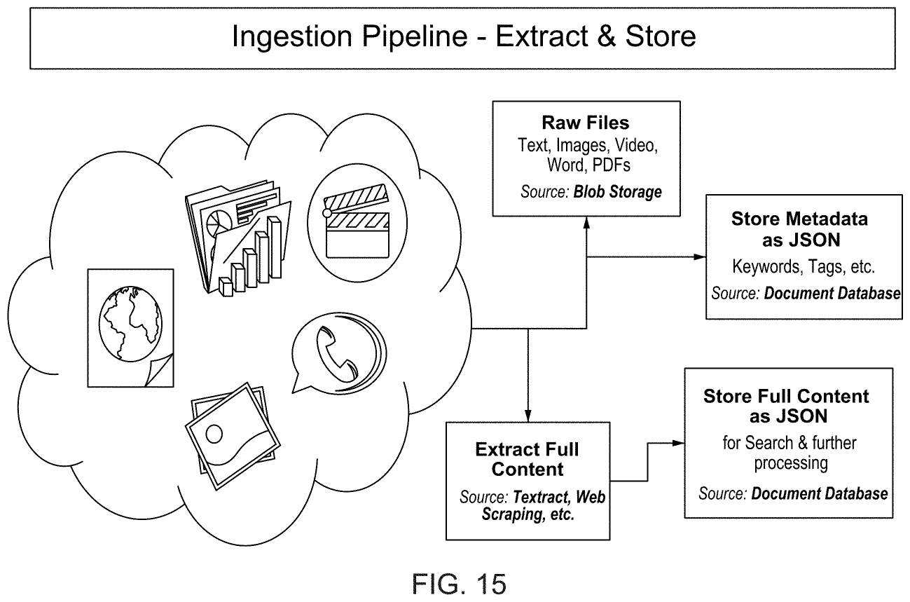

Additional detail on the ingestion pipeline is provided in FIG. 13. Data from sources including SEC filings and reports is stored, analyzed, and parsed into relevant factors which can then be sorted and categorized. Additional examples of data sources are shown in FIG. 14. As shown in FIG. 15, raw reports are stored for archiving and converted to JSON with metadata for storing and manipulation using the systems and methods described herein. Full content of the data is extracted and also stored as JSON.

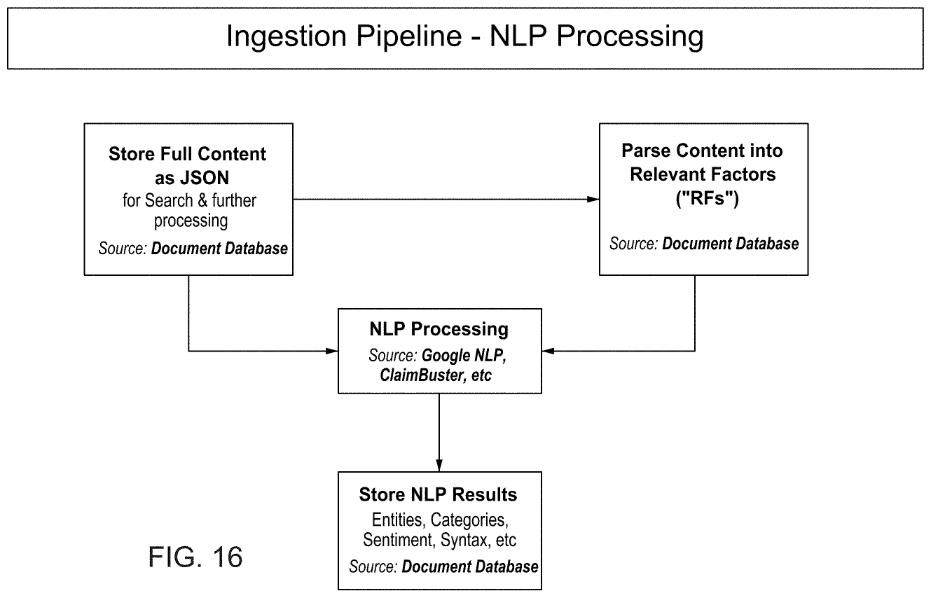

Exemplary NLP processing is shown in FIG. 16. After the full content of the data sources has been stored as JSON, the content can be broken down into sentences/Relevant Factors. The whole data and RF's are initially stored in a SQL database and NLP analysis can then be performed thereon including Google NLP, ClaimBuster, and other services to provide entities, categories, sentiment, syntax, claim scores, etc. The NLP results can then be stored as well. Results can be compared to previous analyses for a given asset to determine changes.

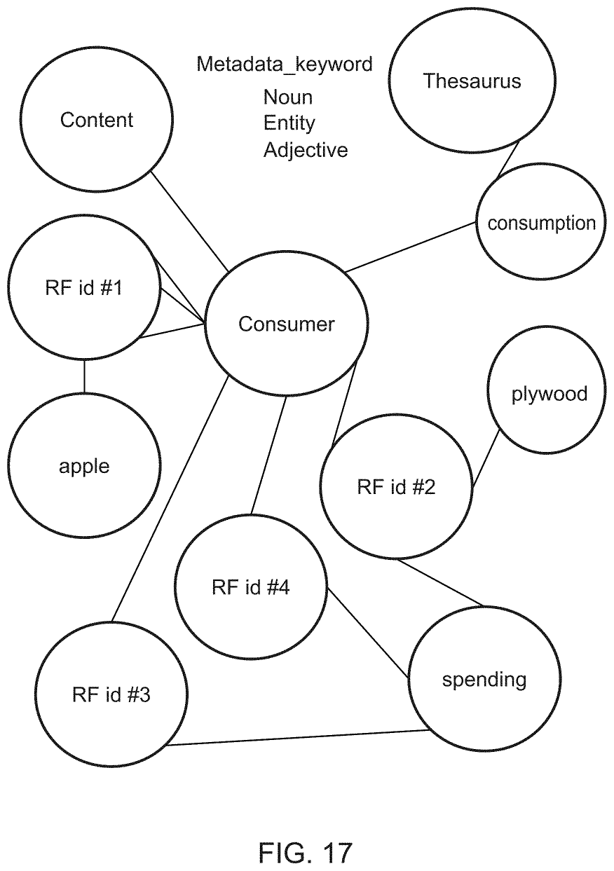

For example, a stock report can be processed and each sentence therein can be assigned as a relevant factor. The NLP analysis can identify key words or phrases in the relevant factor sentences to use as search terms and to aid in classifying the data. The search terms can be graphically represented in a graph database or tree in which the original content is a node under which each relevant factor determined there from is represented as a node falling under the content node. Each keyword or search term identified in each relevant factor can then be depicted as a node falling under the relevant factors. Connecting lines can be used to show the relationship between the search terms or keywords and the various relevant factors from which they were derived such that terms that occur in multiple relevant factors are connected to each of the relevant factors from which they were derived. Multiple connections may be indicative of higher relevance and/or significance for a search term and can be used to rank its importance. An exemplary graphical representation of content, relevant factor, and keyword relationships is shown in FIG. 17.

Derived search terms or combinations thereof can then be queried on, for example, google search or other search engines to generate additional results which can then serve as content to begin the analysis process over again.

Additional tools for NLP analysis include latent semantic analysis in which relationships are analyzed between a set of documents and the terms they contain by producing a set of concepts related to the documents and terms. LSA assumes that words that are close in meaning will occur in similar pieces of text (the distributional hypothesis). SumBasic analysis can be used to determine word frequency in a text. Tools from WordNet, TextRank, LexRank, spaCy, Google AI—Smart Compose, Text Similarity, web scraping tools, elasticsearch, ELK Stack, Lucene, Levenshtein Distance, Faceted Search, Percolate Quary, fuzzy search, edit distance, graph databases and query languages, sentence similarity comparisons, sentiment analysis, and others.

A starting term is sent to WordNet to automatically determine related “sister terms”. The related terms are packaged into a search object (JSON payload) and sent to the search engine which generates queries. The top n search results (e.g., 10, 100, 1000, 10000, or more) are crawled, scraped, and ingested into the databases, along with the relevant terms. NLP processes are then run, especially LSA and LexRank for outliners or words of importance. The process can then repeated through a selected number of cycles or until the number or quality of results have diminished below a determined threshold.

Content ingested into the database by the Simple Related Terms Flow is processed by TextRank to determine the importance of contained relevant factors. Relevant factors are then highlighted and displayed for users to rate Relevance/Significance as a feedback loop to train a machine learning model.

### Example 2—Rules-Based AI/NLP Powered Relevant Factor Index

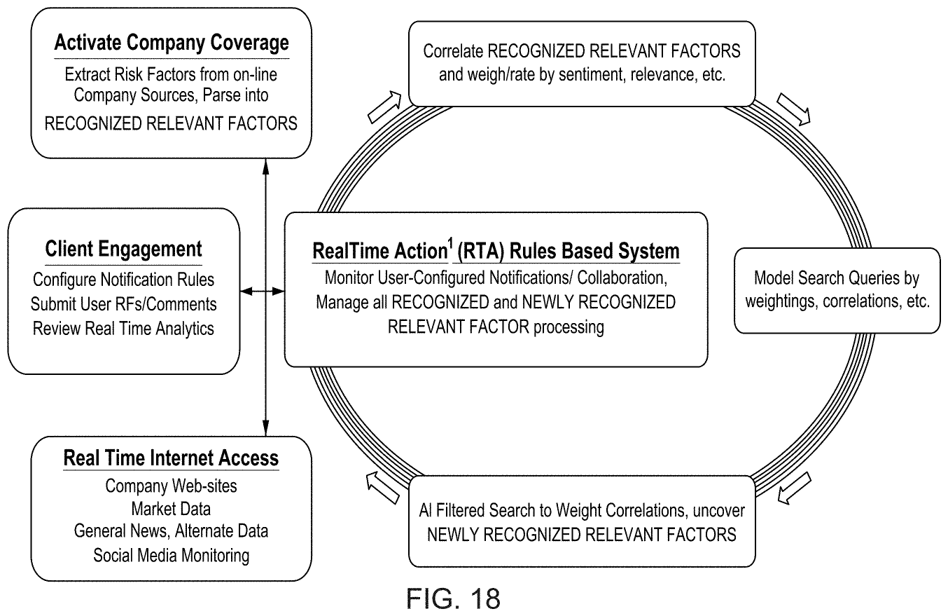

An overview of an exemplary rules-based AI/NLP powered relevant factor index is shown in FIG. 18. Company coverage is activated wherein risk factors are extracted from online company resources and parsed into recognized relevant factors. Client engagement may be used to allow configuration of notification settings (e.g., when and how alerts relevant to the company are provided) along with user-submitted relevant factors and comments. The system, as described herein, can access information in real time through internet searches of company websites, market data, and any other information which may have been or subsequently may be identified as relevant to the company (e.g., general news channels, social media monitoring).

Upon initiation of coverage, the real-time action rules based system monitors user-configured notifications and manages recognized and newly discovered relevant factors and processes the information. Recognized relevant factors are weighted by sentiment, relevance, or other metrics and searched for. Search results are then analyzed to identify new, previously unrecognized relevant factors which are then input-back into the system in an iterative fashion such that factors embodying several degrees of separation are searched and analyzed to uncover new information that may impact the company analysis (e.g., stock price, sell/buy ratings) but was not obviously pertinent prior to the analysis.

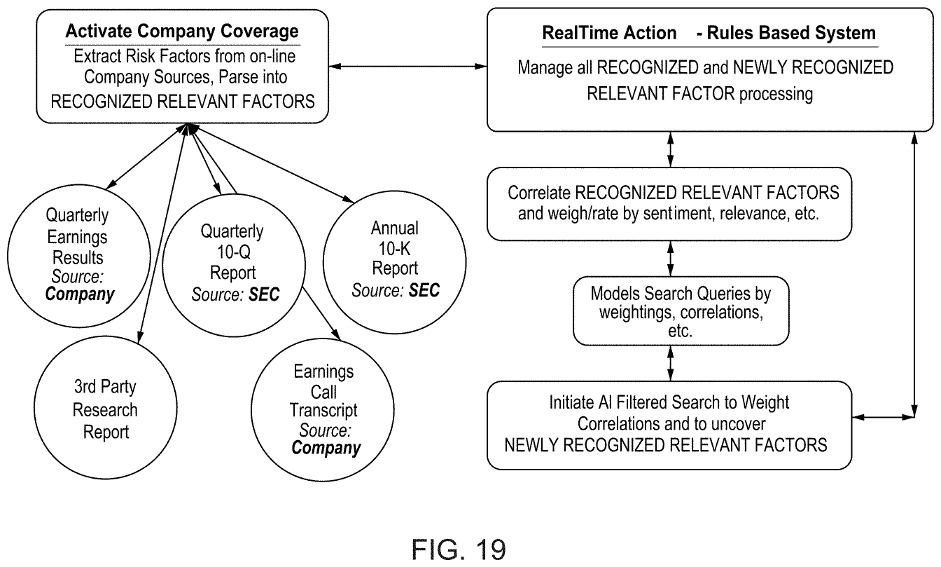

Company coverage activation is shown in FIG. 19. Upon activation, information can be pulled from SEC sources (10-Q or 10-K reports), earnings call transcripts, earnings reports, or various 3rd party research for example. That information can serve as the initial material for NLP processing and identification of relevant factors to be input into the iterative rules-based analysis system to identify newly recognized relevant factors. The recognized relevant factors can then be correlated by weight and rated by sentiment, relevance, etc. Search queries can then be modeled by the weighting and correlations and the now recognized relevant factors can be searched and fed into the system with AI-filtered search to weight correlations, significance and relevance and to uncover new relevant factors. This process can be repeated through multiple iterations. In certain embodiments, the number of iterations may be preset (e.g., six degrees of separation from the initial relevant factors) or may be continued until a threshold of relevance is met (e.g., as measured by weighting, correlation, etc.).

Per the SEC, risk factors includes information about the most significant risks that apply to the company or to its securities. Companies generally list the risk factors in order of their importance. Some risks may be true for the entire economy, some may apply only to the company's industry sector or geographic region, and some may be unique to the company. Risk factor statements from publicly traded companies can be parsed to identify relevant factors such as consumer confidence, inflation, tariffs, tighter credit, etc. That parsing may be automatically conducted using artificial intelligence and natural language processing techniques as described above. Additional relevant factors may be identified from, for example, geographic data provided in a 10-K report.

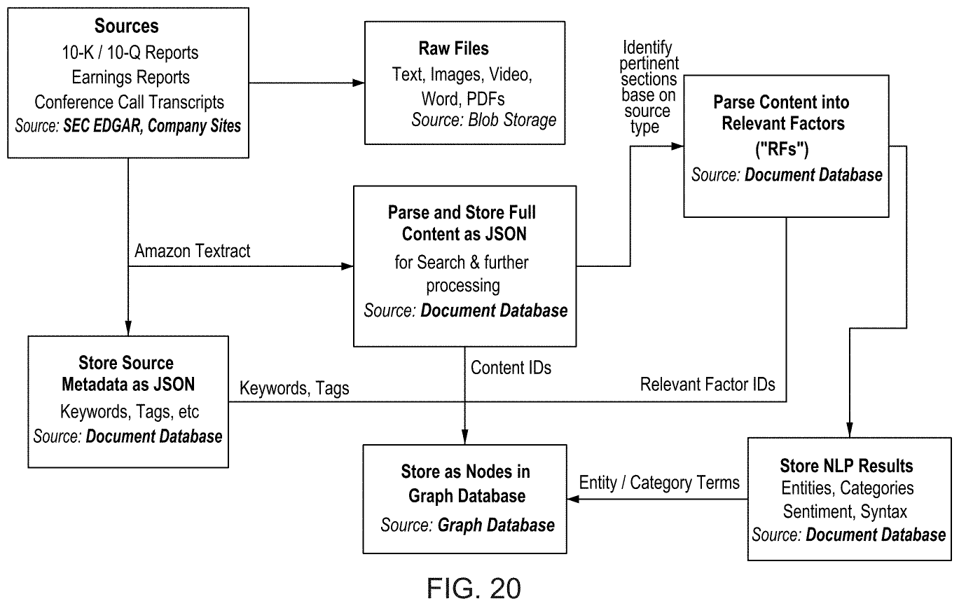

An exemplary information pipeline is shown in FIG. 20. Raw files including text, videos, images, etc. are obtained from sources such as 10-K or 10-Q reports, earnings transcripts, and 3rd party research and the raw files as well as associated metadata (e.g., keywords and tags) can be stored. The metadata can be parsed into relevant factors with, in some cases, a direct import of tags or keywords. Also, the source materials can be parsed and stored in JSON format for analysis. In certain embodiments the data can be stored as nodes in a graph database. NLP results for the source data can also be similarly stored.

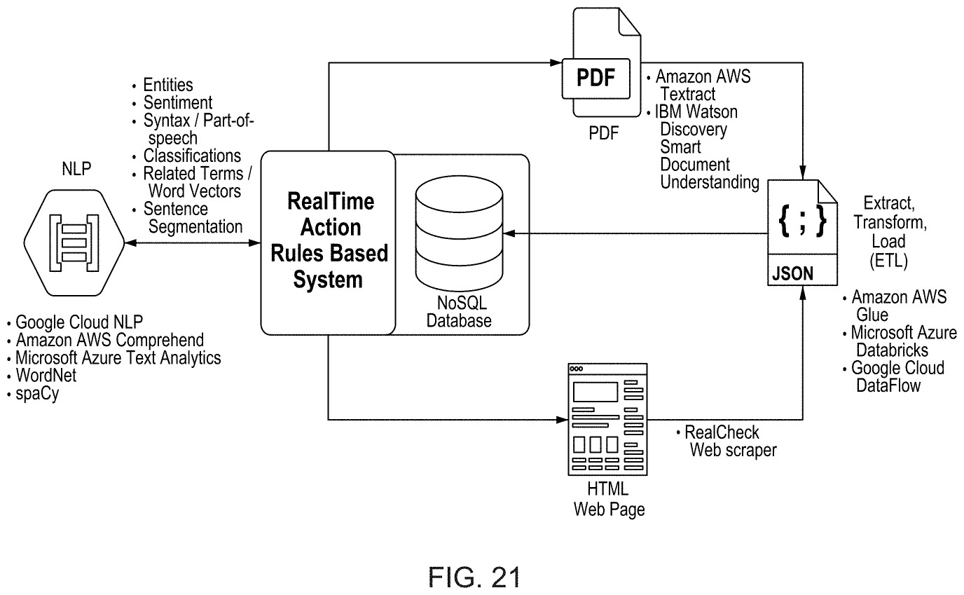

FIG. 21 shows exemplary initial company relevant factor data parsing and NLP flow. The rules-based system uses NLP programs (e.g., Google Cloud NLP, Amazon AWS Comprehend, Microsoft Azure Text Analytics, WordNet, and spaCy) to analyze company content from a NoSQL database. Web pages (e.g., obtained via a web scraper), pdf (e.g., analyzed using Amazon AWS Textract or IBM Watson Discovery Smart Document Understanding), and other content formats and files are extracted and transformed into JSON format (e.g., using Amazon AWS Glue, Microsoft Azure Databricks, and Google Cloud DataFlow) before being placed in the NoSQL database for analysis.

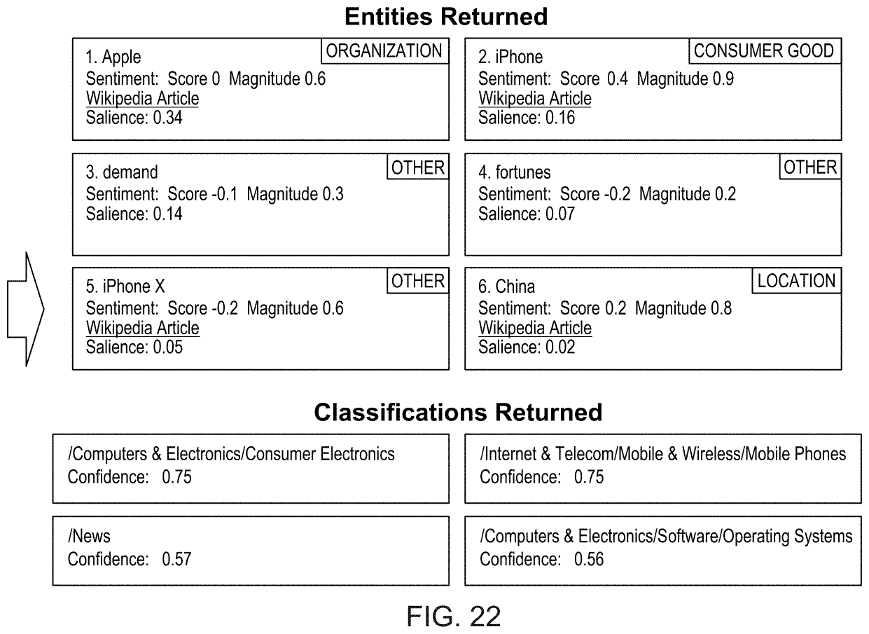

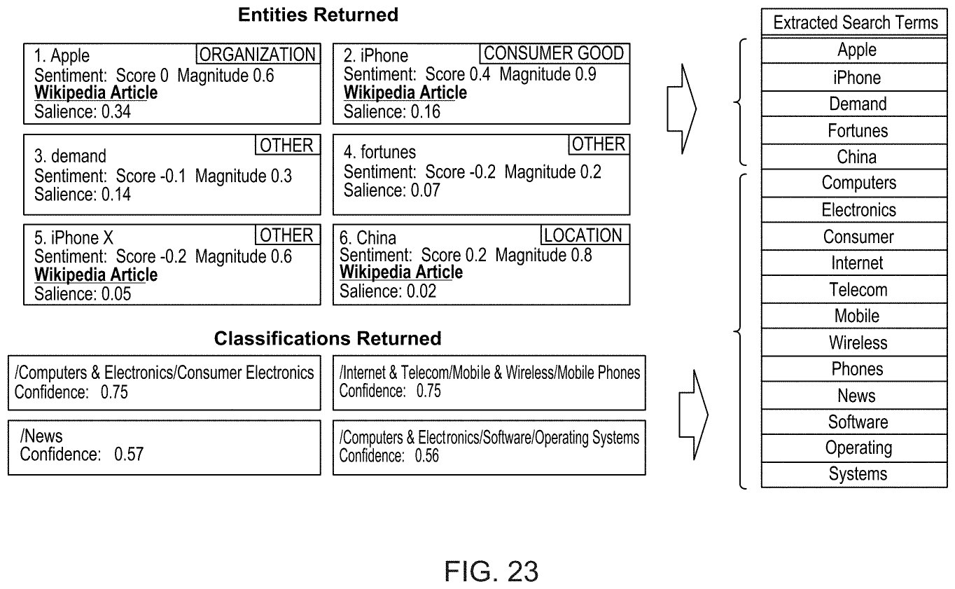

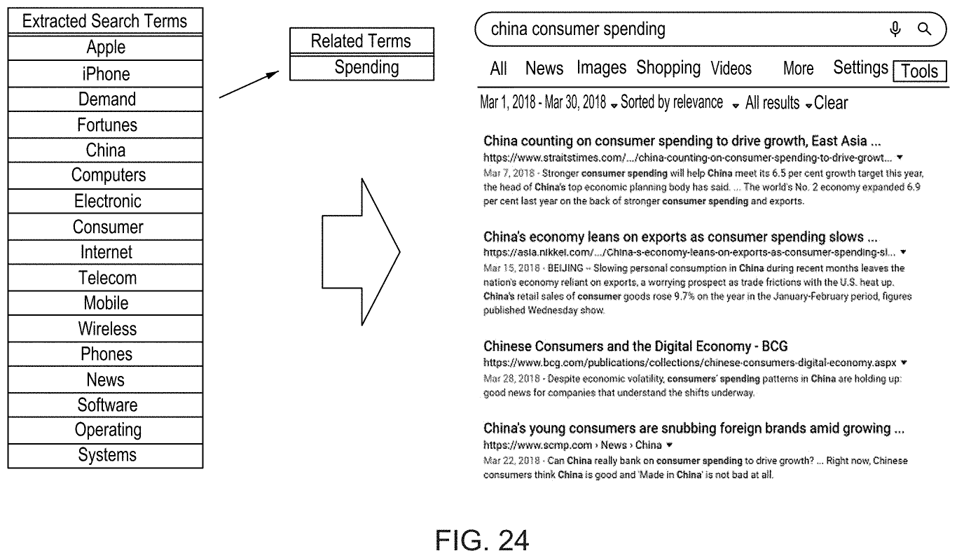

An exemplary analysis for a company is shown in FIGS. 22-25. FIG. 22 shows an exemplary NLP analysis of relevant factors for a company along with the entities and classifications returned through that analysis with salience, relevance, significance and confidence scores. Once those entities and classifications are determined, search terms can be extracted based, for example, on the salience, relevance, significance and confidence scores respectively as shown in FIG. 23 for the company, entities, and classifications from FIG. 22. The search terms can then be further analyzed using, for example, AI or NLP techniques to link individual search terms and provide suggested supplemental terms to create search strings or queries. For example, as shown in FIG. 24, the terms China and Consumer can be identified as related and analysis can suggest the related term spending to create the search query “china consumer spending”. The results can then be further analyzed for new relevant factors and the process can be repeated.

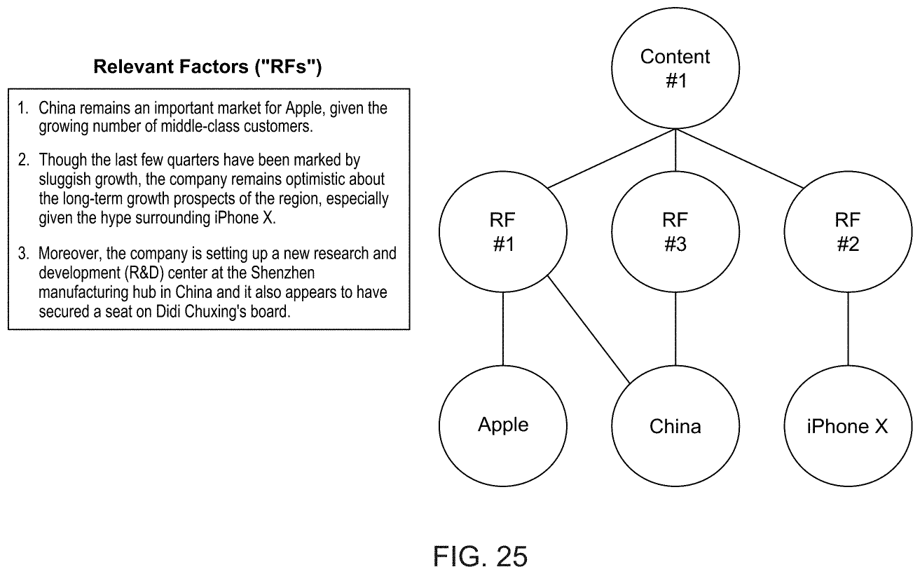

Relevant factors can be processed using, for example, IBM Knowledge Graph to extract unstructured text content from internet searches and content inputs which may be machine learning filtered. The unstructured text can be classified and correlated and the results can be filtered using IBM Watson Discovery Knowledge Graph programming to produce a Knowledge Graph which can then be quarried for weighted/relevant search terms and filtered/weighted relevant factors for user notification using the rules-based system described herein. An exemplary graph database for storing terms and their relationships is shown in FIG. 25. As shown, the content is related to relevant factors 1, 2, and 3 pulled therefrom which are listed on the left of the graph. The terms identified in each relevant factor are then linked with their relevant factors such that terms that appear in multiple relevant factors are linked to each in the graph database (e.g. China in both RF1 and RF3). The IBM Watson Discovery system may be operable within systems and methods of the invention to perform the following:
Continuous Relevancy Training —Using training data and usage, learns the most relevant answers automatically over time;
Embedded NLP—Extracts sentiment, entities, concepts, semantic roles, and more;
Document Similarity—Finds textually similar documents in a collection;
Anomaly Detection—locate unusual data points within a time series and to flag them for further review;
Discovery News—a pre-enriched dataset of news articles that is updated continuously; and
Element Classification—convert, identify, & classify elements of importance - party (who it refers to), nature (type of element), and category (specific class).

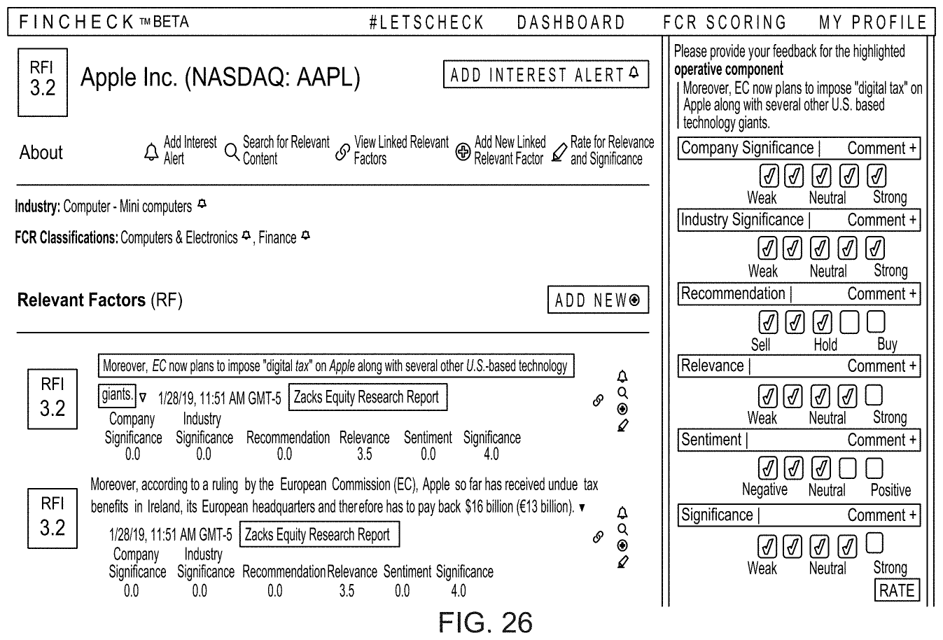

An exemplary user interface for relevant factor index display and user scoring is shown in FIG. 26. Such a user interface provides relevant factors to the user based, for example, on an interest in a company. The interface allows for users reviewing the relevant factors to provide human feedback for the various relevant factors which can supplement the AI analysis and can be incorporated into final ratings based, for example, on user credibility and other scores which may be subject area specific.

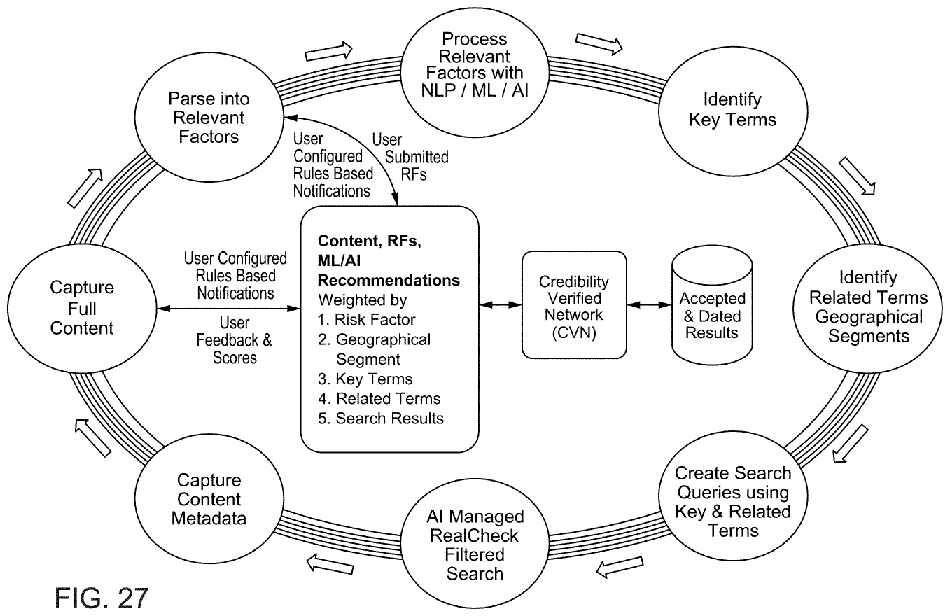

Exemplary relevant factor index scoring is shown in FIG. 27. Content of any form, including metadata, is input into the system and analyzed as described above and parsed into relevant factors. The relevant factors are processed with NLP, machine learning, and artificial intelligence techniques to identify key terms. The key terms are analyzed to identify related terms. The key terms and related terms are combined in various ways to create search queries which are then used in AI managed filtered searches the results of which serve as new content to be run through the above processes again. Content, relevant factors and machine learning or AI recommendations can be provided to the user for feedback and scoring and can be weighted by risk factors, geographical segment, key terms, related terms, relevance, significance and/or search results. The information can be provided to a credibility verified network (human or machine-based) for final review before being deemed accepted.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

1. An automated researching method comprising:
performing two or more iterations of:
obtaining a piece of content;
analyzing the piece of content to identify relevant factors in the piece of content;
processing the relevant factors to identify key terms;
identifying related terms to the key terms;
creating search queries comprising one or more key terms and one or more related terms; and
performing a search to capture additional content.

2. The automated researching method of claim 1 further comprising providing one or more of the content, the relevant factors, the key terms, the related terms, and the additional content to a user for evaluation through a user interface operably coupled to a computer comprising a tangible, non-transitory memory and a processor.

3. The automated researching method of claim 1 wherein content is selected from web pages, 10-K reports, 10-Q reports, conference call transcripts, thesaurus data, social media posts, news articles, geographic associations, source credibility quotients, human feedback, or earning reports.

4. The automated researching method of claim 3 further comprising reformatting the content and storing the processed content in a database.

5. The automated researching method of claim 1 wherein one or more of the analyzing, processing, identifying, creating, and performing steps comprises machine learning, artificial intelligence, or natural language processing.

6. The automated researching method of claim 1 wherein the relevant factors are sentences or sentence fragments.

7. The automated researching method of claim 6 wherein the key terms and related terms are words.

8. The automated researching method of claim 1 further comprising correlating the key terms and storing the key terms and the relevant factors in a graph database.

9. The automated researching method of claim 1 further comprising weighting the key terms.

10. The automated researching method of claim 1 wherein the processing step comprises identifying entities and classifications from the relevant factors, and scoring the entities and classifications based on one or more of salience and confidence.

11. The automated researching method of claim 10 further comprising designating entities and classifications scored above a threshold as key terms.

12. A computerized system comprising a tangible, non-transitory memory and a processor, the system operable to perform the methods of according to claim 1.
